(19) United States
(12) Patent Application Publication
(10) Pub. No.: US 2008/0194305 A1
(43) Pub. Date: Aug. 14, 2008

(54) Bearing assembly and cleaning system in combine harvesters

(76) Inventors: Robert A. Matousek, Milan, IL (US); James R. Schmidt, Andale, KS (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/705,306

(22) Filed: Feb. 12, 2007

(51) Int. Cl. A01F 12/44

(52) U.S. Cl. 460/98; 384/142; 384/599

(57) ABSTRACT

An improved bearing assembly for mounting a drive shaft and bearings, having an upper impeller drive shaft for the tailings conveyor of a combine harvester occupy the same space as the cleaning system rail and seal of a chaffer sieve, is disclosed. The assembly has a flush mounted bearing at one end of the shaft and a normal bearing and lock collar at the shaft's opposite end.

### TECHNICAL FIELD

The present invention relates generally to combine harvesters but, more particularly, to improved sieve operation and grain cleaning.

### BACKGROUND ART

Cleaning systems, for combine harvesters, will cleanse threshed grain by blowing air through a set of planar sieves, utilizing gravitational forces to urge cleaned grain through the sieve openings. However, with higher capacity harvesting machines, the capacity for threshing the grain has increased beyond the throughput capacity of the attendant cleaning systems and the sieve operations. Accordingly, it is desirable to increase both the capacity and the efficiency of the cleaning systems, in combine harvesters, so that such systems contribute to an increase in the combine's overall rate of harvesting.

In the past, this problem has been addressed in rotary cleaning systems by incorporating drive mechanisms compactly situated in a combine base unit where each of the individually driven components of the rotary cleaning device are rotatable about a common axis of rotation, i.e. a cleaning cylinder, an infeed mechanism, a fan, and an impeller are rotatable about said common axis of rotation and a composite drive shaft. The rotary system is discussed in, for example, U.S. Pat. No. 4,422,462 by Frans Decoene.

However, for non-rotary tailings conveyors in combine harvesters, such as disclosed in U.S. Pat. No. 7,028,457 by Schmidt, which enable more efficient conveying of tailings by utilizing threshing plate units installable in a housing with vertically stacked drive shafts, each having a separate axis of rotation, there is a need for improved cleaning efficiencies with far more limited space restrictions.

For example, a crop such as grain which is threshed into the clearances between the combine rotor and its housing, falls through perforations in the housing and is transported to a cleaning system which includes a chaffer sieve stacked atop a shoe sieve. The chaffer sieve and shoe sieve, as two members of the cleaning system, oscillate back and forth. Each sieve has a plurality of apertures for allowing the properly threshed grain to fall therethrough but not the chaff. A blower blows air up though the sieves and out the rear of the combine. The separated chaff will be blown outward along with the air, while the clean grain falls, theoretically, through the sieves onto an inclined plane. Clean grain then travels along the inclined plane and then through a grain elevator to a grain storage area. However, in order to save space, rail and seal attachments to the sieves are contoured in shape to accommodate, during oscillation, certain bearings and lock bars on drive shafts for the tailings conveyor or impeller that extends through the combine side sheets or walls. This contour permits an appreciable amount of clean crop such as grain, corn or beans to fall between the sieves and the side wall, failing therefore to fall onto the inclined plane, and thus never being carried to the grain elevator or storage bin. The combine side wall through which the drive shaft extends, serves as a common wall between the tailings conveyor unit and the combine itself. The wall structurally supports drive shafts, and impellers, from the tailings conveyor unit. Accordingly, there are bearings and lock collars required on the drive shaft which must be avoided by the chaffer sieve by way of a cut-out or a break in the rail and seal, or alternatively the rail and seal can be bent. This contour allows the chaffer sieve's oscillation to occur without rubbing against the bearing and lock collar, and without distorting the rotation of the drive shafts.

A combine design that would enable more perfect seal of the sieves against the combine side wall and inhibit loss of crop, without weakening the impeller drive shafts or distorting shaft rotation would not only reduce crop loss, but save space, and reduce wear and tear on the bearing and lock collar. This would, in turn, satisfy a longfelt need in the industry, provide unexpected efficiencies, and advance the art of combine harvesters.

### SUMMARY OF THE INVENTION

What is disclosed is an improved tailings conveyor bearing assembly, including an improved drive shaft which overcomes one or more of the limitations and shortcomings set forth above.

It is a feature of this invention that the need for lock bars or lock collars for bearing assemblies on the end of the tailings impeller drive shafts located closest to the sieves, is negated.

It is another feature of this invention that the rails and seal will oscillate flush against the drive shafts and bearings without the need for bending or breaking the rail and seal, and will allow greater crop throughput during cleaning.

It is also a feature of this invention that the rotation of the drive shaft and impeller is protected from distortion during contact with the oscillating chaffer sieve's rail and seal.

These and other objects, features and advantages are accomplished according to the instant invention by providing a drive mechanism and assembly for the tailings conveyor cleaning function of a combine harvester. The invention comprises a shaft, having on one end, a self-locking flush mounted bearing, and at its opposite end, a non-locking bearing and a lock collar for mounting between a structural element such as a pulley or sheave and a wall. The first end portion of the drive shaft is configured to be received in a self-locking first bearing such that the shaft extends in a predetermined direction. The second end of the shaft is mounted through a second bearing in an opposite direction but having the same rotational axis as the first bearing, such that the drive shaft is receivable in a second bearing's receptacle but held in place by a spaced apart locking element, as, for example, a locking bar or lock collar.

The invention enables mounting the combine tailing impeller drive shaft adjacent to the body of the combine efficiently, i.e. without loss of crop, or weakening of support, or distorting shaft rotation. The functional areas will all have improved output performances and the drive system will have improved reliability.

### BRIEF DESCRIPTION OF THE DRAWINGS

FIG. 1 is a simplified side view of a combine harvester embodying the relative positioning of the sieves, impellers and drive shafts which function more effectively as a consequence of my invention;

FIG. 2 is a close-up cutaway top view of a prior art combine harvester's bearing assembly and a bent rail seal from the chaffer sieve, which bending is necessitated by the construction of the bearing assembly;

FIG. 3 is a side view of a prior art combine harvester's bearing assembly of FIG. 2 but also illustrating the drive shaft impeller, and top pulley or sheave;

FIG. 4 is a side view of the combine harvester bearing assembly of my invention, further embodying an unbent rail and seal construction;

FIG. 5 is a top view of the combine harvester bearing assembly and the unbent rail and seal of my invention as illustrated in FIG. 4;

FIG. 6 is a cutaway along line 6-6 of FIG. 5, illustrating a side view of the combine harvester bearing assembly of my invention, and also illustrating additional components of this invention;

FIG. 7 is a further side view of the harvesting machine of my invention as illustrated in FIG. 1, depicting an embodiment of a tailings conveyor within the machine, with a cover or wall for the conveyor removed to show internal aspects such as the impeller design details;

FIG. 8 is a perspective view of an embodiment of the conveyor of FIG. 7 in association with a feed auger of the machine for feeding tailings to the conveyor;

FIG. 9 is a simplified perspective view of the tailings conveyor of FIG. 7, showing embodiments of threshing plates of the invention;

FIG. 10 is a simplified perspective view of the tailings conveyor taken along line 10-10 of FIG. 9; and

FIG. 11 is a frontal view of the tailings conveyor housing of FIG. 7 with a cover or wall removed and illustrating tailings being conveyed through the conveyor in a turbulent manner as a result of contact with the threshing plates.

### DETAILED DESCRIPTION OF THE INVENTION

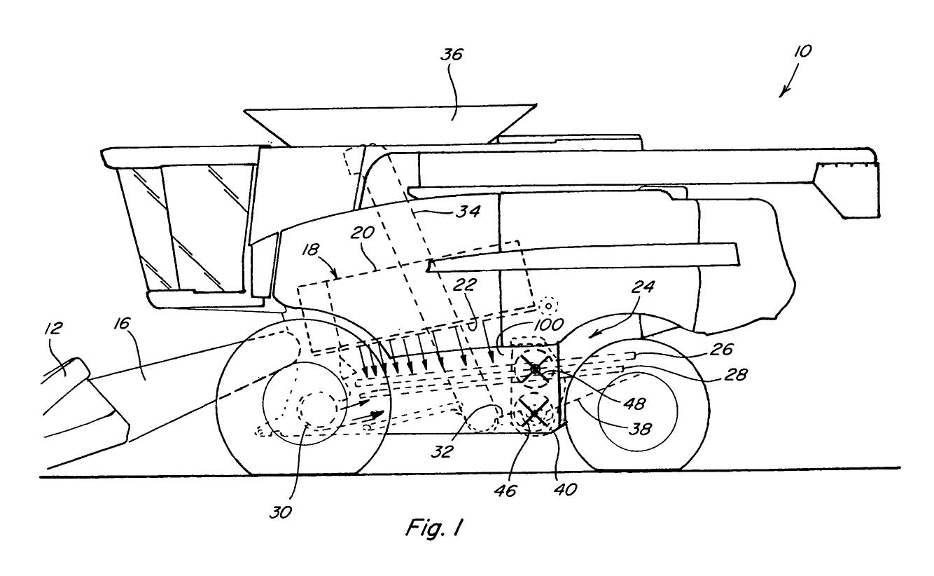

Referring to FIG. 1, an agricultural harvesting machine 10, incorporating the principles of the instant invention, has a header 12, and a feeder 16. Crop material is collected by header 12 and taken into agricultural harvesting machine 10 through feeder 16 in a conventional manner.

A threshing assembly 18 includes a rotor 20 and a perforated housing 22. Rotor 20 is rotated within perforated housing 22. Crop is received from feeder 16 and is passed through clearances between rotor 20 and perforated housing 22 to thresh the crop, e.g. grain. Grain which is threshed in the clearances between housing 22 and rotor 20 falls through the perforations in housing 22 and is transported to a cleaning system 24 including a chaffer sieve 26 and a shoe sieve 28. Chaffer sieve 26 and shoe sieve 28 are members that oscillate back and forth against wall 100 which is a common wall between the tailings housing 40 and the cleaning system. Sieves 26 and 28 have a plurality of apertures for allowing the properly threshed grain to fall through. A blower 30 blows air through sieves 26 and 28 and out the rear of agricultural harvesting machine 10. Chaff will be blown outward along with the air. The clean grain falls through sieves 26 and 28 onto an inclined plane 32. Clean grain travels along plane 32 and then through a grain elevator 34, to a grain storage area 36.

Grain and material other than grain (MOG), which is too heavy to become air borne and falls through chaffer sieve 26 but does not pass through shoe sieve 28 is commonly known as tailings. Tailings end up on a plane 38 and are rethreshed and conveyed in a tailings conveyor 40 and discharged from tailings conveyor 40 onto chaffer sieve 26.

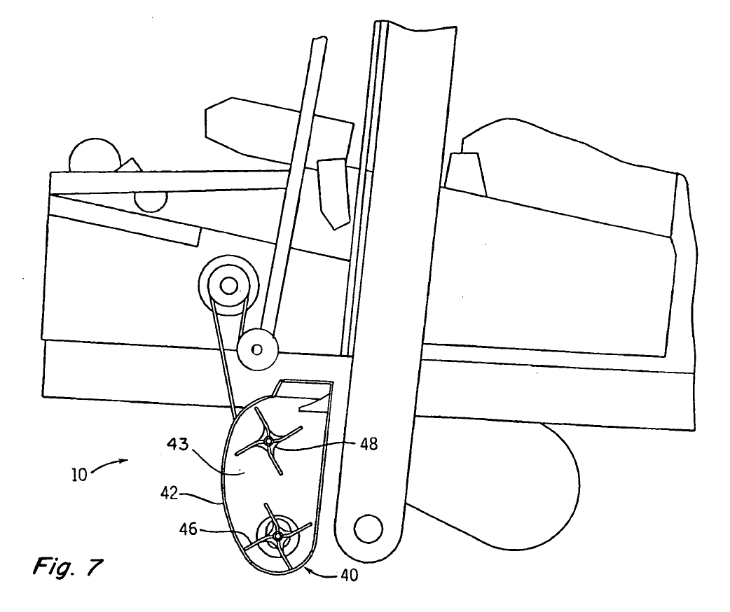

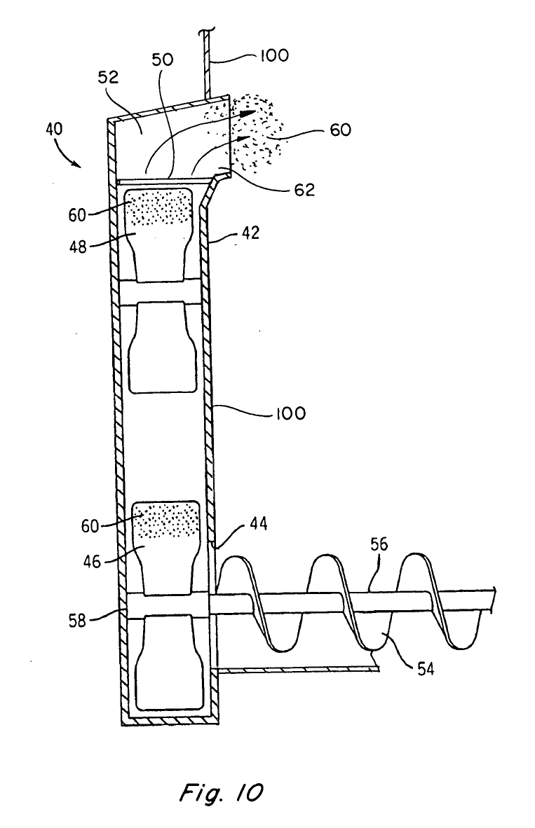

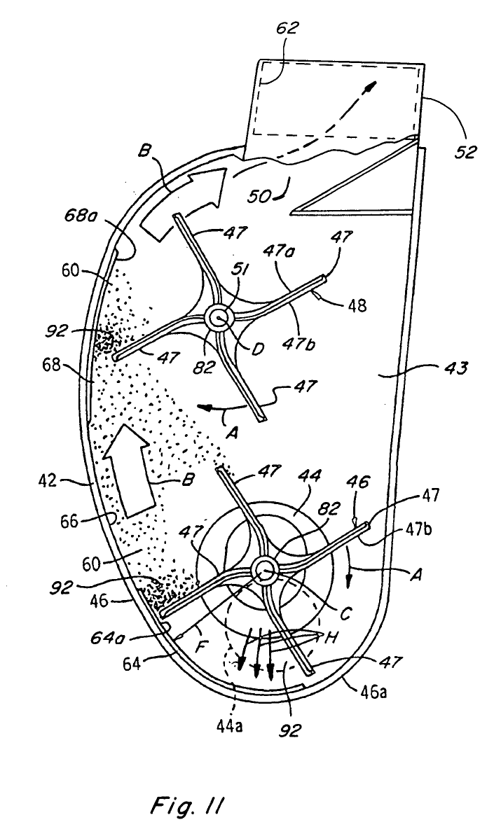

As is best seen in FIGS. 7 through 11, tailings conveyor 40 includes a housing 42 including its wall 100 and an interior portion 43; a first opening 44 (FIG. 9) communicating with interior portion 43; a first rotary impeller 46 and a second rotary impeller 48 located in interior portion 43; and a second opening 50 communicating with interior 43 and a conduit 52. The first and second impellers 46 and 48 are each rotated in predetermined rotational directions A on shafts 58 and 51, respectively, about substantially parallel rotational axes C and D extending longitudinally through the centers of shafts 58 and 51, respectively.

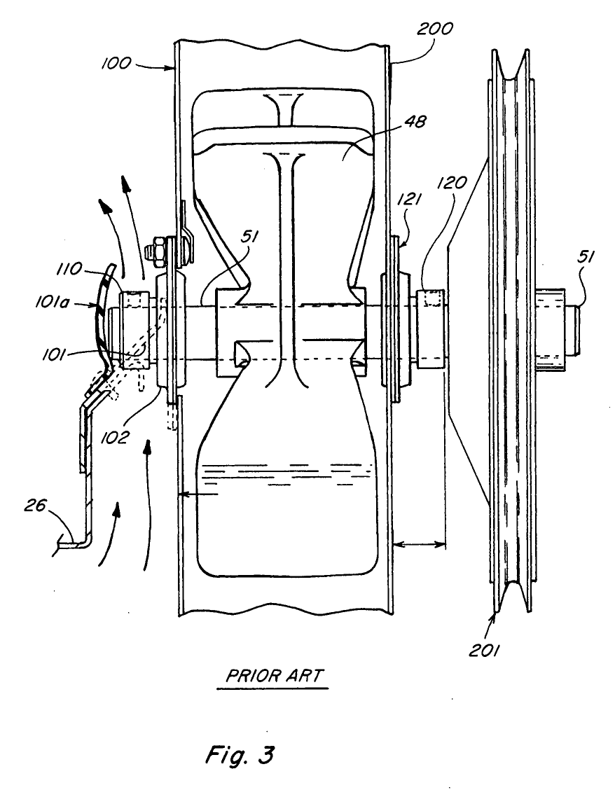

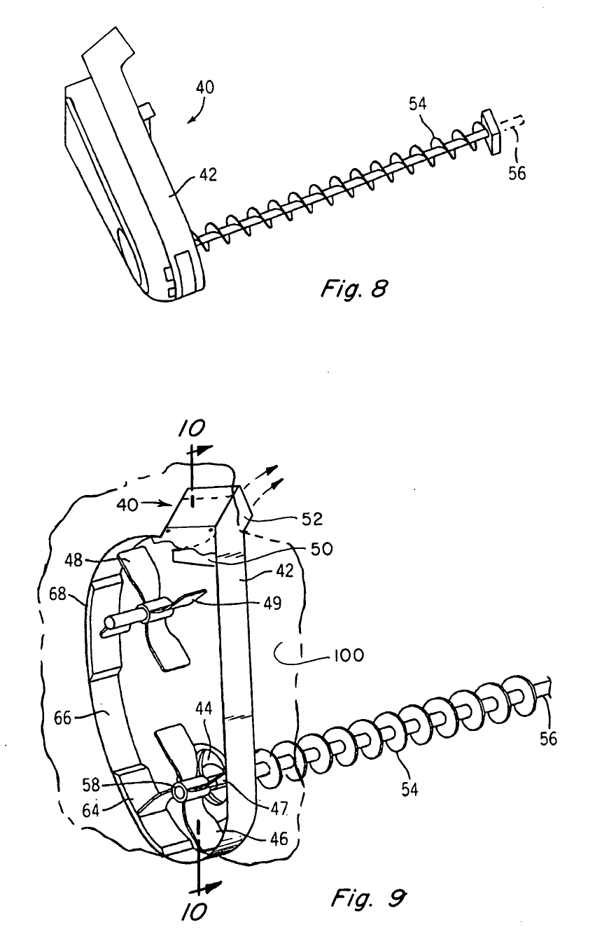

Housing 42 receives the tailings through first opening 44 of wall 100 by means of a conventionally constructed and operable auger 54, as depicted in FIG. 3. Auger 54, as shown in FIGS. 8, 9 and 10, rotates about rotational axis C on a shaft 56 coaxial with shaft 58 for moving the tailings toward tailings conveyor 40, such that the tailings will be discharged by auger 54 through first opening 44 into interior portion 43 of housing 42 in a position to be propelled by rotating first impeller 46 through interior portion 43 to second impeller 48. As an alternative, first opening 44 can be offset from the shaft 58, such as depicted at 44a in FIG. 9, so that, for instance, tailings 60 are delivered into housing 42 at a lower location or more in the vicinity of the radial outer portion of first impeller 46.

First impeller 46, and second impeller 48, each include a plurality of blades 47 extending generally radially outwardly relative to the rotational axis of the respective impeller. Each of the blades 47 is preferably curved or arcuate so as to have a concave surface 47a facing oppositely of the rotational direction A, and a convex surface 47b facing forwardly in or toward the rotational direction A, such that each blade 47 is swept back relative to the rotational direction A, as best shown in FIG. 11.

The impellers 46, 48 and the second opening 50 are preferably radially in-line or aligned, such that tailings 60 which enter housing 42 at opening 44, or 44a, are propelled in rotational direction A by first impeller 46 along a radially inwardly facing threshing surface 64a of a first threshing plate 64, and into the path of rotation of radially adjacent second impeller 48, as denoted by large arrow B. Second impeller 48 will then propel tailings 60 in direction A along a radially inwardly facing threshing surface 68a of a second threshing plate 68, and through second opening 50 into conduit 52. Tailings 60 exit through a discharge outlet 62, so as to be spread over a predetermined region of chaffer sieve 26, or another location if desired. In interior portion 43 of housing 42, a radially inwardly facing common housing wall 66 guides and enhances the radial direction of travel of tailings 60 from first impeller 46 to second impeller 48.

The preferred rotational direction A for both of impellers 46 and 48 is clockwise. The curved or arcuate or swept back shape of the blades 47 on impellers 46 and 48 has been found to cause a more aggressive threshing of tailings 60 and forces the tailings 60 to the radially outer portion of the blades 47 faster, which has been found to increase conveying capacity. Threshing plate surfaces 64a and 68a may each have a rough surface texture or smooth, and/or can include elements such as raised protuberances and the like, for imparting a desired turbulence to the tailings flow, for performing a desired threshing function, as discussed in more detail below.

Impellers 46 and 48 each include a mounting portion 82 which is preferably a hub, mountable to a rotatable member, such as shaft 58 of conveyor 40 in the instance of impeller 46, for rotation with the rotatable member in a predetermined rotational direction, such as direction A, about a rotational axis, such as axis C, as best shown in FIG. 11. Each impeller 46 and 48 includes a plurality of blades 47, preferably four in number, which extend generally radially outwardly from mounting portion 82 at equally spaced locations around the rotational axis. As noted before, each blade 47 includes a surface 47a facing in a direction opposite the rotational direction, and a surface 47b facing in the rotational direction.

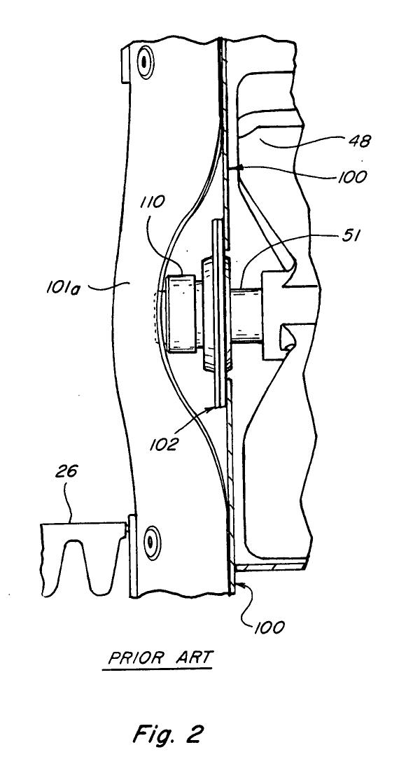

Referring back now to prior art FIGS. 2 and 3, the prior art cleaning systems required a conventional bearing 102 and locking collar 110 on the end of shaft 51 on the opposite side of wall 100 from the impeller 48. This construction necessitated bending of wiper seal 101a which was connected to chaffer sieve 26, which bending weakens the integrity of the seal and allows grain unseparated from the chaff to fall through the resulting opening between seal 101a and wall 100.

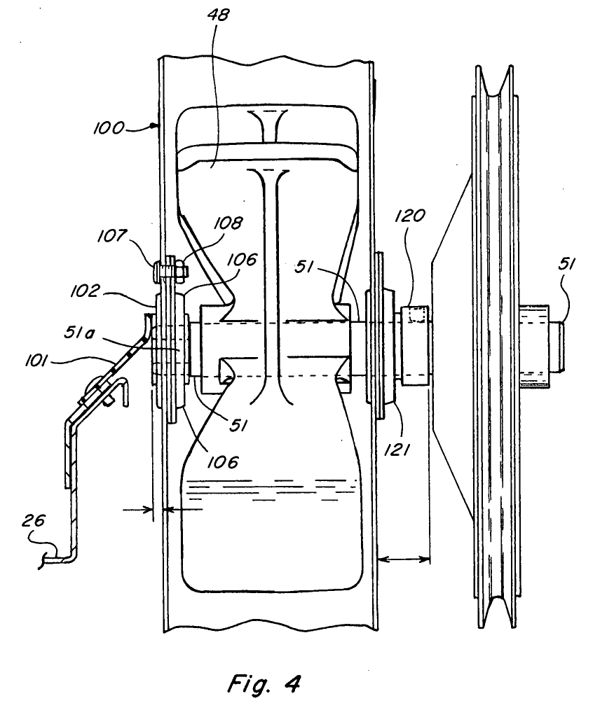

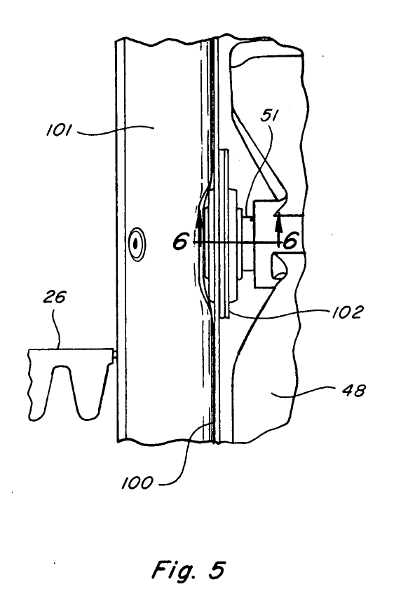

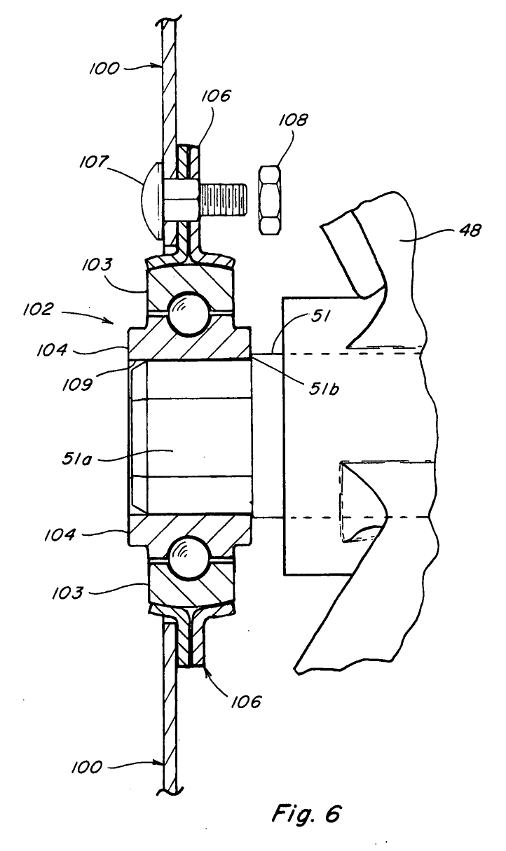

Referring to FIGS. 4, 5 and 6, the bearing assembly 102 of the present invention contains a polygonal or, preferably hexagonal interior profile within the bearing surface 109 which receives a congruently profiled stub shaft end 51a of shaft 51, which stub shaft end 51a is therefore configured in a polygonal fashion for secure engagement with the inner surface 109 of bearing 102. The walls 104 of bearing 102 define the inner race for the bearing. Walls 103 of bearing 102 define the inner race of bearing 102. Shoulder 51b of shaft 51 rests firmly against bearing 102 and walls 104. Connectors, such as carriage bolts 107 and nut 108, can secure, for example, a mounting flange 106 for mounting bearing 102 to the wall 100, or side sheet or alternatively 100 can be a cover. The bearing assembly of the present invention enables a stronger wiper seal construction 101 as depicted in FIG. 5 which has greater integrity and can be flush mounted against wall 100, thus preventing loss of grain or other crop and providing for a more efficient cleaning system.

Conventional bearing 121 is mounted around shaft 51 and locking collar 120 is spaced apart relationship between wall 200 and sheave or pulley 201.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. An assembly for improved drive functionality, said assembly comprising first and second spaced side sheets, the first side sheet and an annularly enclosed hex bearing mounted substantially flush to said first side sheet, and said bearing having mounted on its surface outboard of the first side wall, a cleaning system rail and seal;
said hex bearing having an annular bearing housing but a bearing-receiving cavity configured in cross-section as an equilateral polygon such that each face of said cavity is tangential to a bearing received therein;
the polygonal cavity securing a stub shaft having congruent polygonal cross-section and said stub shaft extending as an end point from a shoulder abutment of a drive shaft supporting fan member rotatably engaged between said first side sheet and said second side sheet;
said second side sheet receiving an opposite end of the drive shaft through an annular opening in said second side sheet having mounted within said annular opening a conventional bearing abutted to and cooperating with a locking collar located on the outboard side of said second side sheet; and
said drive shaft continuing through to support a sheave or pulley member.

2. A bearing assembly, comprising in combination:
a shaft having an end portion having a multiple-sided outer surface portion;
a first bearing, including a mounting portion supporting an outer bearing race, the outer bearing race extending around and supporting an inner bearing race for rotation relative thereto about a first rotational axis through the inner bearing race, the inner bearing race including a multiple-sided surface portion disposed around the first rotational axis and defining a first receptacle aligned with the first rotational axis and configured for matingly receiving the multiple-sided outer surface portion of said end portion of the shaft sufficiently for supporting the end portion of the shaft for joint rotation of the shaft with the inner race about the first rotational axis;
a second bearing including a second mounting portion supporting a second outer bearing race, the second outer bearing race extending around and supporting a second inner bearing race for rotational relative thereto about a second rotational axis therethrough, the second inner bearing race including a second receptacle therein configured for receiving the shaft, and a locking element in connection with the second inner bearing race configured for holding the shaft in the second receptacle axially in relation to the second rotational axis; and
wherein the mounting portion of the first bearing is configured to be mounted on a side of a first structural element with the first receptacle facing in a predetermined direction away from the first structural element, the end portion of the shaft is receivable in the first receptacle such that the shaft extends in the predetermined direction, the second mounting portion is configured to be mounted on a second structural element spaced in the predetermined direction from the first structural element with the second rotational axis axially aligned with the first rotational axis, and such that the shaft is receivable in the second receptacle and held by the locking element so as to be rotatable about the rotational axes relative to the sheet and the structural element without moving axially relative thereto.

3. The bearing assembly of claim 1 or 2 wherein an impeller is mounted on the shaft between the first and second bearings and between the first and second side sheets.

4. An improved combine harvester having the bearing assembly of claim 1 or claim 2.
